(19) United States
(12) Patent Application Publication
(10) Pub. No.: US 2017/0006212 A1
(43) Pub. Date: Jan. 5, 2017

(54) DEVICE, SYSTEM AND METHOD FOR MULTI-POINT FOCUS

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/812,189

(22) Filed: Jul. 29, 2015

(30) Foreign Application Priority Data
Jul. 1, 2015 (CN) 201510377827.9

(51) Int. Cl. H04N 5/232; H04N 5/272; G06T 7/00

(52) U.S. Cl. CPC H04N 5/23212; H04N 5/23229; G06T 7/0051; H04N 5/23293; H04N 5/272; G06T 2207/10028; G06T 2207/10148; G06T 2207/20216; G06T 2207/20221

(57) ABSTRACT

An electronic device achieving multi-point focus of a scene includes a digital camera, a depth-sensing camera, at least one processor, a storage device, a display device, and a multi-point focus system. The system receives one or more points designated by a user from an image of a scene previewed by the digital camera, and analyzes the one or more designated objects to be focused. Distances between the digital camera and each designated object to be focused are determined and the digital camera adjusts a focal length according to each distance. Images of the same scene at each focal length are captured and the images captured by the digital camera are processed to generate a new image which includes all of focus objects. The new image is output through the display device.

### CROSS-REFERENCE TO RELATED APPLICATIONS

This application claims priority to Chinese Patent Application No. 201510377827.9 filed on Jul. 1, 2015, the contents of which are incorporated by reference herein.

### FIELD

The subject matter herein generally relates to image focus technique. More particularly, the present application relates to a device, system, and method for multi-point focus.

### BACKGROUND

In geometrical optics, a focus, also called an image point, is the point where light rays originating from a point on the object converge. In recent years, cameras provided with a multi-point focus system for determining a focus state (defocus) at each of a plurality of focus detection zones (focus points) have been developed. However, in the original multi-point focus system, the focus points cannot be designated by a user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of hardware architecture of an electronic device.

FIG. 2 is a block diagram of one embodiment of function modules of a multi-point focus system.

FIG. 3 is a flowchart of one embodiment of a multi-point focus method.

FIG. 4 is a flowchart of one embodiment of a detail description of one block in FIG. 3.

FIG. 5 is a diagrammatic view of an example of a scene being imaged.

FIG. 6 is a diagrammatic view of an example of confirming an object to be focused.

FIG. 7 illustrates different objects to be focused in the scene of FIG. 5.

FIG. 8 illustrates a new image being obtained.

### DETAILED DESCRIPTION

It will be appreciated that for simplicity and clarity of illustration, where appropriate, reference numerals have been repeated among the different figures to indicate corresponding or analogous elements. In addition, numerous specific details are given in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

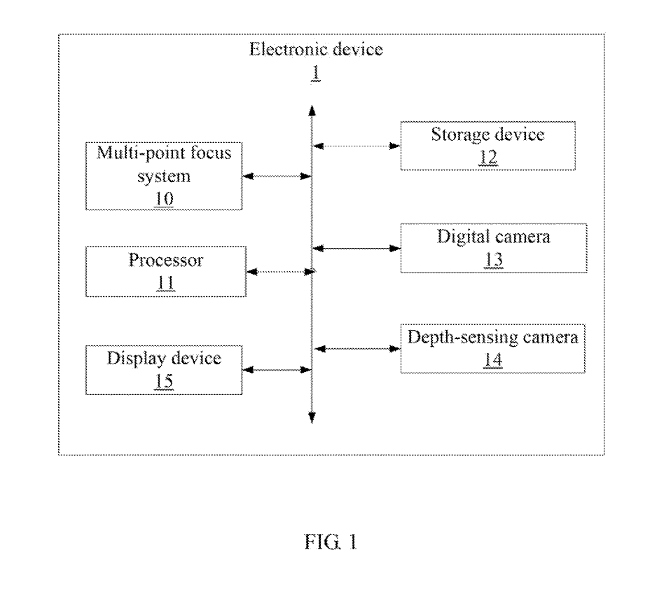

FIG. 1 is a block diagram of one embodiment of hardware architecture of an electronic device. In one embodiment, the electronic device 1 may be a smart phone, a tablet PC, a notebook computer, and so on. The electronic device 1 may include a multi-point focus system 10, at least one processor 11, a storage device 12, a charge-coupled device (CCD) camera 13, a depth-sensing camera 14, and a display device 15.

In one embodiment, the impact preventing device 1 includes a depth-sensing camera 10, at least one processor 11, a storage device 12, a multi-point focus system 13, an actuator 14, an impact preventing unit 15, and a touch sensor 16.

The at least one processor 11 can be central processing unit (CPU), a microprocessor, or other data processor chip.

The storage device 12 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 12 can also be an external storage system, such as a hard disk, a storage card, or a data storage medium.

The digital camera 13 use an electronic image sensor, usually a charge coupled device (CCD) or a Complementary Metal Oxide Semiconductor (CMOS) sensor to preview or capture images of a current scene, and transfers or stores the captured images in a memory card or other storage, such as the storage device 12

The depth-sensing camera 14 may be a time-of-flight camera (TOF camera), which is a camera system that creates distance data based on the time-of-flight (TOF) principle. A scene is illuminated by short light pulses and the camera measures the time taken for the reflected light to reach the camera again. This time is directly proportional to the distance. The camera therefore provides a range value for each pixel.

The display device 15 is an output device for visual presentation of information, such as presenting the images captured by the digital camera 13.

The multi-point focus system 10 includes computerized codes that, when executed by the at least one processor 11, can capture images of a scene according to different objects to be focused designated by a users, and can process the images to generate a new image which includes all of the objects to be focused. The computerized codes of the multi-point focus system 10 can be stored in the storage device 12.

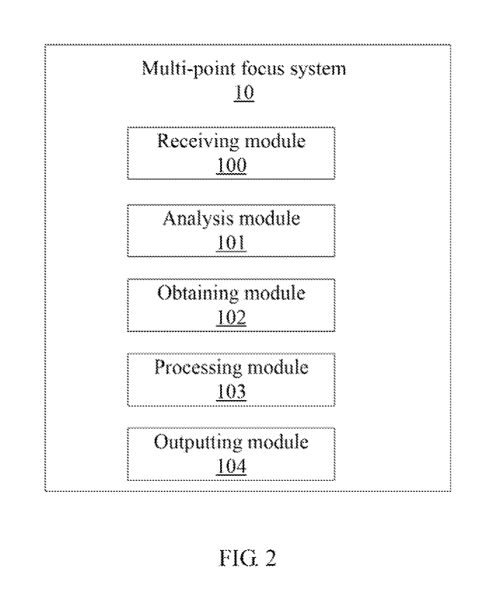

FIG. 2 is a block diagram of one embodiment of function modules of the multi-point focus system. In one embodiment, the function modules of the multi-point focus system 10 can include a receiving module 100, an analysis module 101, an obtaining module 102, a processing module 103, and an outputting module 104.

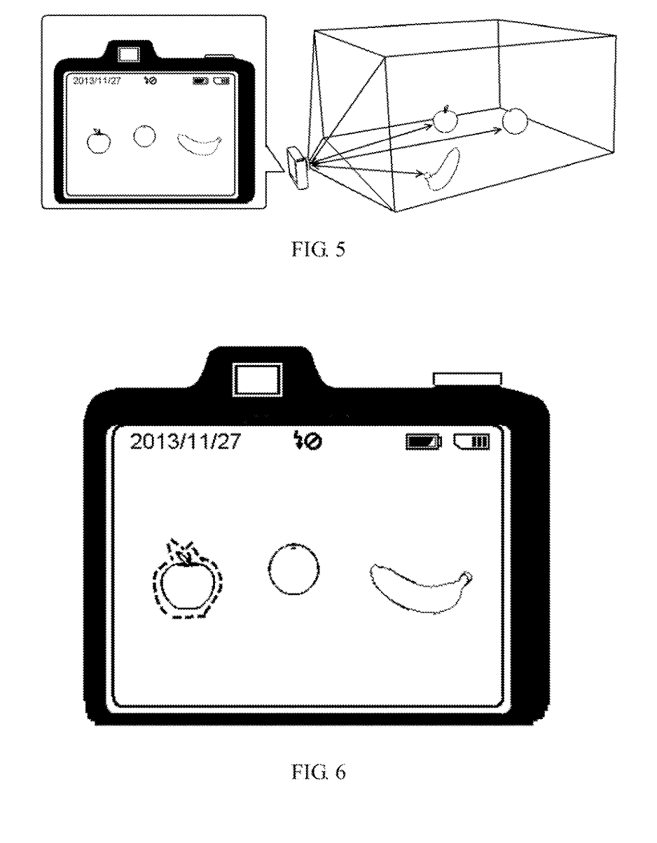

The receiving module 100 can receive one or more points designated by a user from an image of a current scene previewed by the digital camera 13. Referring to FIG. 5, the digital camera 13 previews an image of a scene which includes a banana, an apple, and an orange, and displays the preview image on the display device 15. The banana, the apple, and the orange have different distances to the digital camera 13 (each distance can be called a Z-depth). The user can designate one or more points from the preview image through the display device 15.

The analysis module 101 can analyze one or more objects to be focused according to the one or more designated points. In one embodiment, the analysis module 101 can detect an object which includes a pixel corresponding to one of the designated points in the preview image. The object is one of the objects to be focused. Furthermore, the analysis module 101 marks the analyzed object to be focused using a predetermined method, to be confirmed by a user. Referring to FIG. 6, in an example, the analysis module 101 can use a dotted line to surround an analyzed object to be focused. The user can confirm or deny the analyzed object to be focused using a predetermined physical or virtual key.

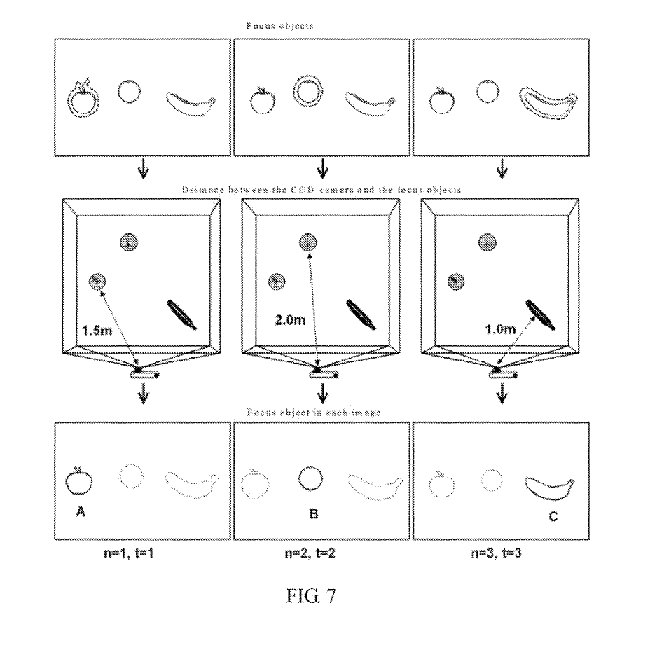

The obtaining module 102 can obtain a distance between the digital camera 13 and each of the objects to be focused from the depth-sensing camera 14. As mentioned above, the depth-sensing camera 14 illuminates a short light pulses to the objects to be focused in the scene, and measures the time taken until the reflected light reaches the camera again, to compute the distance between the depth-sensing camera 14 and each object to be focused. It may be understood that, the distance between the depth-sensing camera 14 and each object to be focused can be considered to be the same as the distance between the digital camera 13 and each object to be focused. Thus, the digital camera 13 can adjust a focal length according to each distance between the digital camera 13 and an object to be focused, and capture images of the same scene at each of focal lengths, referring to FIG. 7.

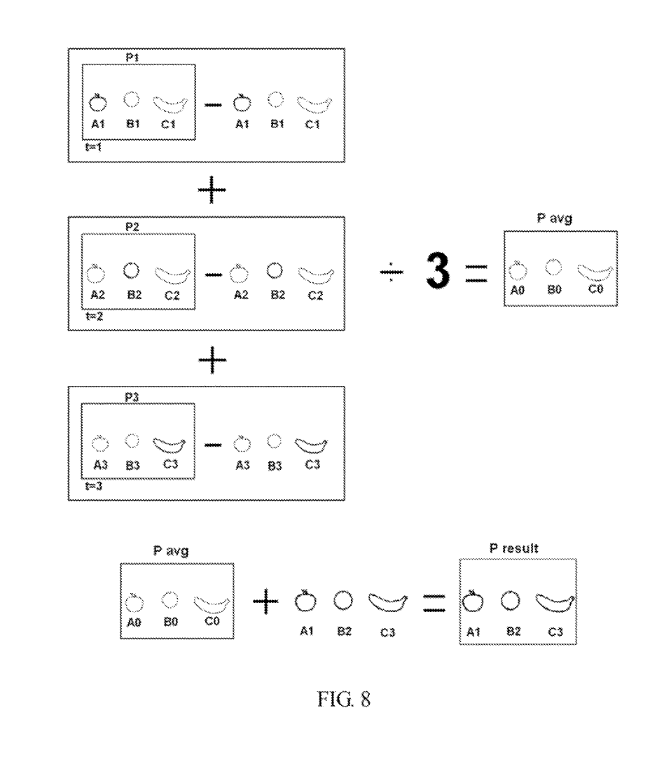

The processing module 103 can process the images captured by the digital camera 13, to generate a new image which includes all of focus objects. In one embodiment, referring to FIG. 8, the process module 103 abstracts the focus objects in each of the images (for example, the apple, the orange, and the banana), averages the images, from each of which the focus objects have been abstracted, to generate a background image, and integrates the focus objects into the background image to generate the new image.

The outputting module 104 can output the new image through the display device 15.

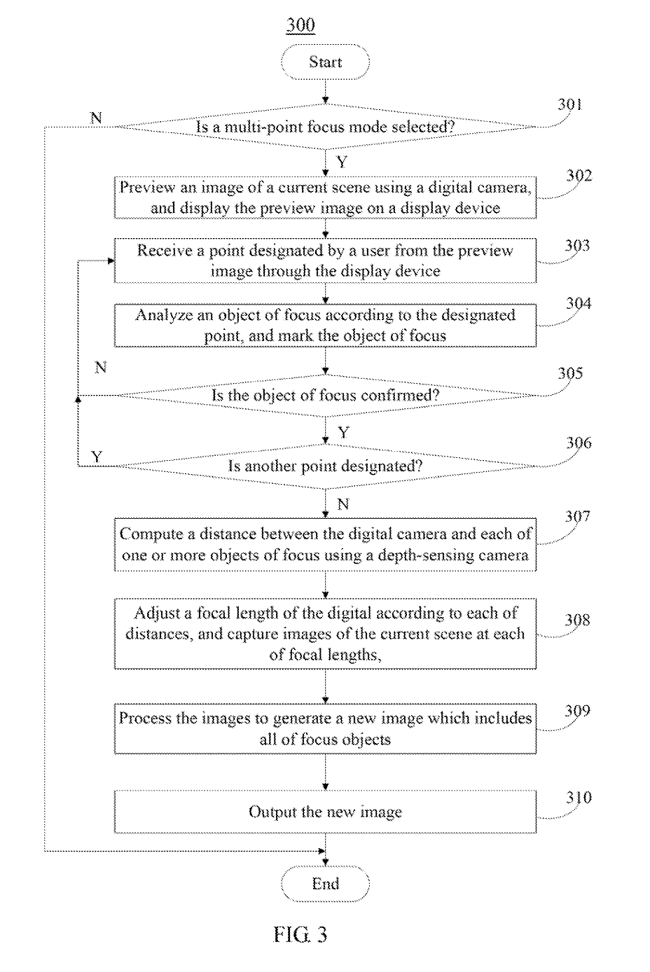

FIG. 3 is a flowchart of one embodiment of a multi-point focus method.

Referring to FIG. 3, a flowchart is presented in accordance with an example embodiment illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods, or subroutines carried out in the exemplary method 300. Furthermore, the illustrated order of blocks is by example only and the order of the blocks can change. Additional blocks may be added or fewer blocks may be utilized, without departing from this disclosure. The exemplary method 300 can begin at block 301.

At block 301, a determination is made as to whether a multi-point focus mode being selected. The user can select the multi-point focus mode using a predetermined key, such as a physical key or a virtual key. When the multi-point focus mode is selected, block 302 is implemented. Otherwise, until the multi-point focus mode is selected, the procedure does not progress.

At block 302, a scene is previewed by a digital camera, and a preview image is displayed on a display device. In an example, as illustrated in FIG. 5, the scene includes a banana, an apple, and an orange. The banana, the apple, and the orange are at different distances from the digital camera.

At block 303, a point can be designated by a user from the preview image of the scene through the display device.

At block 304, an object to be focused is analyzed according to the designated point, and the analyzed object to be focused is then marked. In one embodiment, an object which includes a pixel corresponding to the designated point in the preview image is the object to be focused. Referring to FIG. 6, in an example, a dotted line can be used to surround the analyzed object to be focused. The user can confirm or deny an object to be focused using a predetermined physical key or a virtual key, for example.

At block 305, a determination as to whether the object to be focused being confirmed. If the object to be focused is denied, block 303 is repeated. If the object to be focused is confirmed, block 306 is implemented.

At block 306, a determination is made as to whether another point in the preview image being designated is made. If another point in the preview image is designated, block 303 is repeated. Otherwise, if no other point is designated, block 307 is implemented.

At block 307, a depth-sensing camera computes the distance between the digital camera and each of the one or more objects to be focused by emitting short light pulses to the objects to be focused in the scene, and measuring the time taken until the reflected light reaches the camera again. An obtaining module obtains distances between the digital camera and each of the objects to be focused from the depth-sensing camera.

At block 308, the digital camera adjusts a focal length according to the distance between the digital camera and each of the objects to be focused, and captures images of the same scene at each focal length, referring to FIG. 7

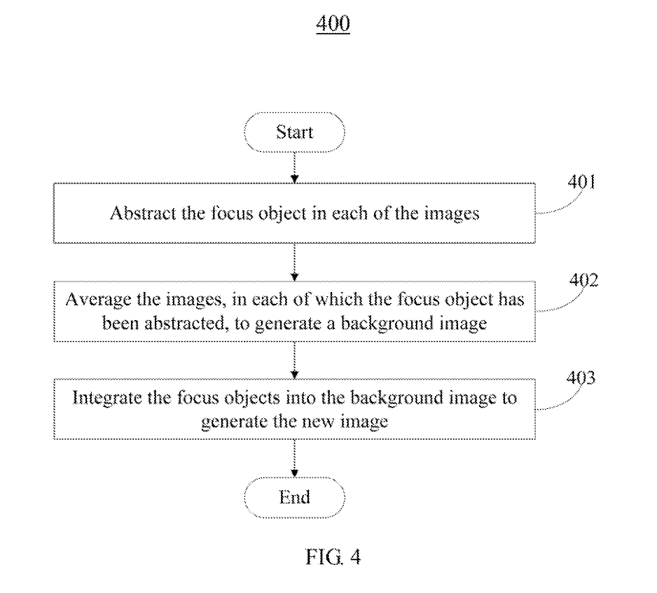

At block 309, the images captured by the digital camera are processed to generate a new image which includes all of focus objects. Description is given with reference to FIG. 4.

At block 310, the new image can be outputted through the display device 15.

FIG. 4 is a flowchart of one embodiment of a detail description of block 308 in FIG. 3.

At block 401, referring to FIG. 8, the focus objects in each of the images (for example, the apple, the orange, and the banana) are abstracted.

At block 402, an averaging operation is applied to the images, in each of which the focus objects have been abstracted, to generate a background image,

At block 403, the focus objects then are integrated in to the background image to generate the new image.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device, comprising a digital camera, a depth-sensing camera, at least one processor, a storage device, and a display device, each of which connects to each other using data bus; the electronic device further comprising a multi-point focus system, wherein the multi-point focus system comprises one or more programs stored in the storage device, which when executed by the at least one processor, cause the processor to:
receive one or more points designated by a user from an image of a scene previewed by the digital camera;
analyze one or more objects to be focused according to the one or more designated points;
obtain a distance between the digital camera and each of the one or more objects to be focused from the depth-sensing camera;
control the digital camera to adjust a focal length according to each of distances, and capture images of the scene at each of focal lengths;
process the captured image, and generate a new image which includes all of focus objects based on the processed image; and
control the display device to display the new image.

2. The electronic device according to claim 1, wherein the depth-sensing camera is a time-of-flight camera (TOF camera).

3. The electronic device according to claim 1, wherein the multi-point focus system is further configured to:
mark the analyzed object to be focused using a predetermined method, for being confirmed by the user.

4. The electronic device according to claim 3, wherein the analyzed object to be focused is marked using a dotted line to surround an analyzed object to be focused.

5. The electronic device according to claim 1, wherein the images captured by the digital camera are processed by:
abstracting the focus object in each of the images;
averaging the images, in each of which, the focus objects have been abstract, to generating a background image; and
integrating the focus objects in to the background image to generate the new image.

6. The electronic device according to claim 1, wherein the one or more objects to be focused are analyzed by:
detecting an object which includes a pixel corresponding to one of the designated points in the preview image, wherein the object is one of the one or more objects to be focused.

7. A multi-point focus method, comprising:
receiving one or more points designated by a user from an image of a scene previewed by a digital camera;
analyzing one or more objects to be focused according to the one or more designated points;
obtaining a distance between the digital camera and each of the one or more objects to be focused from a depth-sensing camera;
controlling the digital camera to adjust a focal length according to each of distances, and capture images of the scene at each of focal lengths;
processing the captured image, and generate a new image which includes all of focus objects based on the processed image; and
controlling a display device to display the new image.

8. The multi-point focus method according to claim 7, wherein the depth-sensing camera is a time-of-flight camera (TOF camera).

9. The multi-point focus method according to claim 7, further comprising:
marking the analyzed object to be focused using a predetermined method, for being confirmed by the user.

10. The multi-point focus method according to claim 9, wherein the analyzed object to be focused is marked using a dotted line to surround an analyzed object to be focused.

11. The multi-point focus method according to claim 7, wherein the images captured by the digital camera are processed by:
abstracting the focus object in each of the images;
averaging the images, in each of which, the focus objects have been abstract, to generating a background image; and
integrating the focus objects in to the background image to generate the new image.

12. The multi-point focus method according to claim 11, wherein the one or more objects to be focused are analyzed by:
detecting an object which includes a pixel corresponding to one of the designated points in the preview image, wherein the object is one of the one or more objects to be focused.

13. A non-transitory storage medium having stored thereon instructions that, when executed by at least one processor of an electronic device, causes the at least one processor to perform a multi-point focus method, the method comprising:
receiving one or more points designated by a user from an image of a scene previewed by a digital camera;
analyzing one or more objects to be focused according to the one or more designated points;
obtaining a distance between the digital camera and each of the one or more objects to be focused from a depth-sensing camera;
controlling the digital camera to adjust a focal length according to each of distances, and capture images of the scene at each of focal lengths;
processing the captured image, and generate a new image which includes all of focus objects based on the processed image; and
controlling a display device to display the new image.

14. The non-transitory storage medium according to claim 13, wherein the method further comprises:
marking the analyzed object to be focused using a predetermined method, for being confirmed by the user.

15. The non-transitory storage medium according to claim 14, wherein the analyzed object to be focused is marked using a dotted line to surround an analyzed object to be focused.

16. The non-transitory storage medium according to claim 13, wherein the images captured by the digital camera are processed by:
abstracting the focus object in each of the images;
averaging the images, in each of which, the focus objects have been abstract, to generating a background image; and
integrating the focus objects in to the background image to generate the new image.

17. The non-transitory storage medium according to claim 13, wherein the one or more objects to be focused are analyzed by:
detecting an object which includes a pixel corresponding to one of the designated points in the preview image, wherein the object is one of the one or more objects to be focused.
